(19) United States
(12) Patent Application Publication
(10) Pub. No.: US 2025/0061520 A1
(43) Pub. Date: Feb. 20, 2025

(54) Construction Inventory Tool

(71) Applicant: Construction Analytics Group, Ltd., Castle Rock, CO (US)

(72) Inventors: Andrew Behrens, Castle Rock, CO (US); Kyle Larson, Parker, CO (US)

(21) Appl. No.: 18/804,795

(22) Filed: Aug. 14, 2024

Related U.S. Application Data
(60) Provisional application No. 63/532,580, filed on Aug. 14, 2023.

(51) Int. Cl. G06Q 40/08; G06Q 10/087

(52) U.S. Cl. CPC G06Q 40/08; G06Q 10/087

(57) ABSTRACT

Methods and systems are described for deriving repair quote estimates. Embodiments can calculate the quotes using several variables. Methods can include obtaining the variables from servers with storage and processes dedicated to maintaining the accuracy of the data. A calculation can then be performed according to a formula, which outputs a final repair quote estimate to the user.

### CROSS REFERENCE TO RELATED INFORMATION

This application claims the benefit of United States of America priority application No. 63/532,580 filed on Aug. 14, 2023, titled “Construction Inventory Tool,” the contents of which are hereby incorporated herein in its entirety.

### TECHNICAL FIELD

The present disclosure generally relates to systems and methods for estimating repair costs for a proposed job.

### BACKGROUND

The construction industry often relies on information from the insurance industry, especially when dealing with repairs. When insured buildings need repairs, insurance claims are made to insurance companies, and there is pressure from insurance companies to keep the repair cost low. Insurance companies can sometimes rely on software tools, such as Xactimate, to predict, control, or standardize repair costs.

However, repair quote systems employed by the insurance company present challenges when applied to the construction industry. Insurance companies often base their predicted costs on inventory, supply, and cost assumptions that are not widely applicable, which makes estimates inaccurate for construction purposes.

### SUMMARY

One embodiment under the present disclosure comprises a method performed by an inventory tracking system for deriving repair costs for a proposed repair job. The method comprises tracking inventory cost and status for one or more items used in repairs; tracking equipment cost and status for one or more items used in repairs; receiving a repair job; determining materials costs for the repair job; determining equipment costs for the repair job; determining a number of worker hours needed for the repair job; determining a retail labor rate related to the repair job, wherein the retail labor rate comprises worker wages, labor burden and labor overhead; adjusting the labor overhead portion of the retail labor rate; and calculating a repair estimate for the proposed repair job based at least in part on the material costs, the equipment costs, the worker hours, and the retail labor rate, wherein the retail labor rate is based on the adjusted labor overhead.

Another embodiment under the present disclosure is a system for tracking inventory and material costs and providing repair estimates. The system comprises processing circuitry and a memory. The memory contains instructions executable by the processing circuitry whereby the system is operative to: track inventory cost and status for one or more items used in repairs; track equipment cost and status for one or more items used in repairs; receive a repair job; determine materials costs for the repair job; determine equipment costs for the repair job; determine a number of worker hours needed for the repair job; determine a retail labor rate related to the repair job, wherein the retail labor rate comprises worker wages, labor burden, and labor overhead; adjust the labor overhead portion of the retail labor rate; and calculate a repair estimate for the proposed repair job based at least in part on the material costs, the equipment costs, the worker hours, and the retail labor rate, wherein the retail labor rate is based on the adjusted labor overhead.

Another embodiment under the present disclosure is a method performed by an inventory tracking system for deriving repair costs for a proposed repair job. The method comprises receiving a repair cost estimate from a third party estimate system related to a repair job; and adjusting the received repair cost estimate by adjusting the labor overhead portion of the retail labor rate.

This summary is provided to introduce a selection of concepts in a simplified form that are further described below in the detailed description. This summary is not intended to identify key features or essential features of the claimed subject matter, nor is it intended to be used as an indication of the scope of the claimed subject matter.

### BRIEF DESCRIPTION OF THE DRAWINGS

For a more complete understanding of the present disclosure, reference is now made to the following descriptions taken in conjunction with the accompanying drawings, in which:

FIG. 1 illustrates an example of a system for estimating repair quotes;

FIG. 2 illustrates an example of a computing device included as part of a system for estimating repair quotes;

FIG. 3 illustrates a method for using a system for estimating repair quotes using internal data to calculate the quote; and

FIG. 4 illustrates a method for using a system for estimating repair quotes using a quote from a third party system to calculate the quote.

### DETAILED DESCRIPTION

Before describing various embodiments of the present disclosure in detail, it is to be understood that this disclosure is not limited to the parameters of the particularly exemplified systems, methods, apparatus, products, processes, and/or kits, which may, of course, vary. Thus, while certain embodiments of the present disclosure will be described in detail, with reference to specific configurations, parameters, components, elements, etc., the descriptions are illustrative and are not to be construed as limiting the scope of the claimed embodiments. In addition, the terminology used herein is for the purpose of describing the embodiments and is not necessarily intended to limit the scope of the claimed embodiments.

There exist certain challenges in the prior art of construction and repair inventory management and cost quoting and estimating. A “repair quote system” can be used to refer to a network serving to draw information from many sources to accurately determine a price to execute a defined task. This means that a repair quote system can fetch data from a database to calculate a projected cost. Some values may be set based on constant costs independent from the relevant market, and others may be variable, matching costs that are unique to a particular market. Certain prior art repair quote systems used in the insurance and construction industries take average materials costs, and an average hourly worker rate, and create average repair costs. For example, for repairing a roof of a certain size, a set amount of materials predicted for such a job may have price “a.” Cost of the equipment is defined as “b,” for equipment needed to perform the repair. There would also be a set amount of man hours predicted to finish the job, defined as “c” hours. Taking a retail labor rate, “d,” determined by the particular region of the country, and may include some allowance for markup, gives a total cost of repair of: Cost=($a+$b+(c hours*d $/hr)). The repair quote system Xactimate, for example, outputs values for a, b, c, and d for a given repair job in a given location. In Xactimate, the retail labor rate d is made up of three components, d=$x+$y+$z, where x=workers' wage, y=labor burden, z=labor overhead. The problem with this approach and others like it is that they ignore the circumstances of each individual repair company and broader circumstances, such as supply chain issues that affect inventory, parts, labor, and other costs

Certain aspects of the disclosure and their embodiments may provide solutions to these or other challenges not solved by the prior art. Certain embodiments may provide one or more of the following technical advantages. Instead of rigid cost estimates which do not account for the specific circumstances of a construction company, certain embodiments may account for the present availability of inventory, vehicles, equipment, labor, and other factors which produce accurate cost estimates. The respective inventory can then be set aside for a given job or construction project, allowing for more accurate inventory management.

Some of the embodiments contemplated herein will now be described more fully with reference to the accompanying drawings. Embodiments are provided by way of example to convey the scope of the subject matter to those skilled in the art.

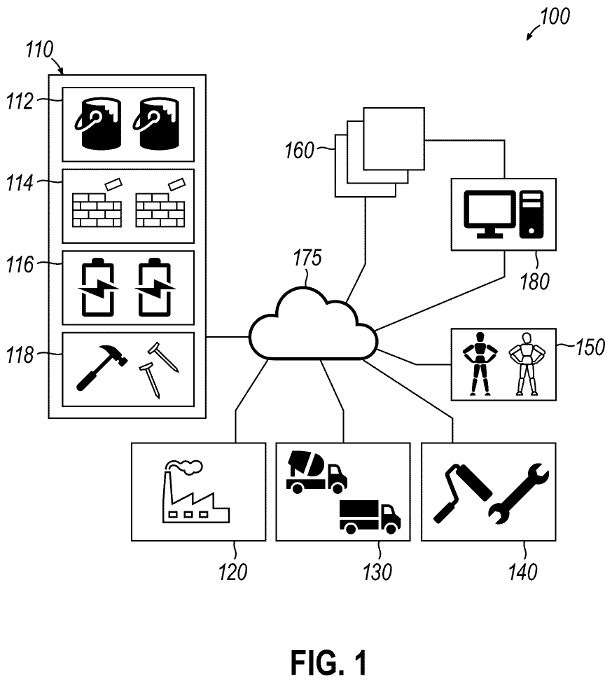

An embodiment under the present disclosure is shown in FIG. 1. System 100 includes capabilities for monitoring inventory 110, physical plant 120, vehicle 130, equipment 140, and labor 150 costs. These factors can be monitored and quickly incorporated into the planning of a repair company, such as for delivering quotes for specific repairs. Inventory 110 can include various types of supplies, such as paint 112, bricks 114, batteries 116, tools 118, and/or other items. System 100 comprises one or more servers 160 that can track numbers of each item in inventory 110. Network 175 (e.g., Wi-Fi, Internet, LAN (local area networks), etc.) can comprise communicative coupling between items or resources to be tracked (e.g., 110-150) and servers 160 and/or computer 180. Servers 160 can comprise, or be communicatively to, computer 180. Computer 180 can comprise other user interface tools 180 such as screens, keyboards, smartphones, or other devices. Computer 180 can alternatively be independently connected to network 175. Amounts can be input manually by a user, or various tracking systems can be used. Physical plant 120 can include office space, laboratory locations, factories or other manufacturing facilities, and similar costs that go into a company's overhead. These factors can be tracked by system 100, such as via e.g., servers 160. Vehicles 130 can also be monitored. Number of vehicles 130, costs of maintenance and repair, fueling, depreciation, and other factors can be included and tracked by system 100 via servers 160. Costs related to equipment 140 can also be tracked. Costs for labor 150 can also be tracked.

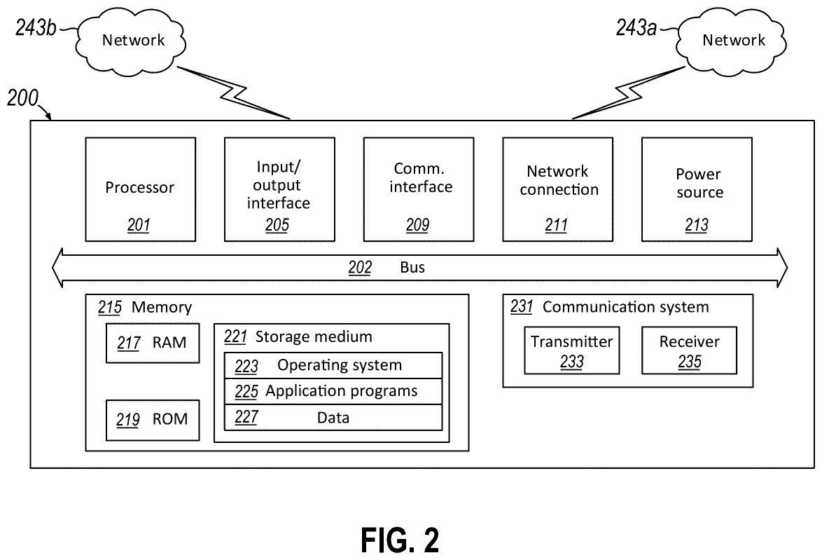

FIG. 2 shows an embodiment of a computing device (such as computer 180 or server 160 of FIG. 1) 200 in accordance with some embodiments. As used herein, a computing device 200 refers to a device capable, configured, arranged and/or operable to communicate wirelessly with other computers, servers, or items or resources (such as elements 110 to 150 of FIG. 1) to be tracked or monitored or input into strategy or budgeting tools. Examples of a computing device 200 include, but are not limited to, a server, a smart phone, desktop computer, smart device, vehicle-mounted or vehicle embedded/integrated wireless device, etc.

Computing device 200 comprises processor 201 that is coupled via a bus 202 to multiple components, which may include an input/output interface 205, a power source 213, a memory 215, a communication interface 209, network connection 211 (e.g., ethernet cable), a communication system 231, and/or other components or combinations thereof. Further, certain computing devices may contain more or fewer instances of a component, such as multiple memories, receivers, processors, transceivers, transmitters, etc.

Processor 201 can be configured to execute instructions stored as machine-readable computer programs in memory 215. Processor 201 may be implemented as one or more stored computer programs, general-purpose processors, together with appropriate software; or any combination of the above. For example, processor 201 may include multiple central processing units (CPUs).

Input/output interface 205 may be configured to provide an interface(s) to one or more input and/or output devices. Examples of output devices include a speaker, a display, a printer, another output device, or any combination thereof. An input device may allow a user to capture information into computing device 200. Examples of input devices include a touch-sensitive or presence-sensitive display, a camera, a microphone, a mouse, a keyboard, and the like.

In some embodiments, the power source 213 is structured as one or more batteries. Other types of power sources, such as an external power source (e.g., an electrical outlet) may be used. The power source 213 may further include circuitry for delivering power from the power source 213 itself, and/or an external power source, to the other components of the computing device 200. Delivering power may be, for example, for charging of the power source 213. Power source circuitry may perform formatting, converting, or other modification to the power to make the power suitable for the respective components of the computing device 200.

Memory 215 may be configured to include memory such as random access memory (RAM), read-only memory (ROM), magnetic disks, hard disks, flash drives, and similar types of memory. In certain embodiments, memory 215 includes one or more application programs 225, such as an operating system 223, web browser application, a widget, or other types of applications, and corresponding data 227. Memory 215 may store, e.g., for use by the computing device 200, a variety of operating systems or combinations thereof.

Memory 215 may comprise one or more physical drive units, including flash memory, USB flash drive, external hard disk drive, thumb drive, internal hard disk drive, other storage types, or any combination thereof. Memory 215 allows the computing device 200 to access and use instructions, application programs, data, and the like, stored on transitory and/or non-transitory storage media. An article of manufacture may be tangibly embodied in the memory 215, which may comprise a device-readable storage medium.

Processor 201 may communicate with network 243a, 243b, or another network using the communication interface 209. Communication interface 209 may comprise one or more communication systems 231 and may include or be communicatively coupled to an antenna comprising or coupled to one or more transmitters 233 and/or one or more receivers 235.

In the illustrated embodiment, communication functions of the communication interface 209 may include cellular communication, Wi-Fi communication, short-range communications such as Bluetooth, near-field communication, use of the global positioning system (GPS), or any combination thereof.

A computing device 200, when in the form of an Internet of Things (IoT) device, may comprise any of a variety of devices. Non-limiting examples of such an IoT device include: a TV, a connected lighting device, a voice controlled smart speaker, a security camera, a motion detector, a door/window sensor, a weight sensor in an inventory warehouse, an electrical door lock, a surveillance system, and others. A computing device in the form of an IoT device comprises circuitry and/or software in dependence of the intended application of the IoT device in addition to other components as described in relation to the computing device 200 shown in FIG. 2.

Referring again to system 100 of FIG. 1, several sources of information can be combined to assess inventory status and include costs from all monitored sources to create up-to-date repair costs for a given repair job. Labor 150 can include calculation of various labor related costs, such as FICA (Federal Insurance Contributions Act), payroll taxes, workers' compensation, insurance, benefits, and/or other costs). Overhead costs may comprise costs of physical plant 120, and possibly some vehicle 130 or equipment 140 costs. Material costs may include costs related to inventory 110, overhead costs, and/or some equipment 140 costs. One other source of overhead cost, material costs, and labor costs may be a company's profit and loss statements. These statements typically also show revenue of a company. Using these data sources can provide an up-to-date, and present inventory-based, quote for various repair jobs.

As described above, prior art (e.g., Xactimate) calculated repair costs based on cost=($a+$b+(c hours*d $/hr)). The retail labor rate d is made up of three components, d=$x+$y+$z, wherein x=workers' wage, y=labor burden, z=labor overhead. There is often general agreement in a given market (e.g., North Texas) on values a, b, c, and x and y of d. Workers' wage x is the hourly rate earned by the worker. Labor burden y includes things like FICA, payroll taxes, workers' compensation (e.g., costs that are usually fixed). However, there can be a need to adjust z, labor overhead. System 100 of FIG. 1 can track and/or calculate z based on various, individualized, company metrics or circumstances. It can also provide more accurate data to track (e.g., in real time) prices of materials a and equipment b. The tracking of material costs (including inventory), overhead costs, labor costs, and revenue, allows for more accurate and up-to-date repair costs. Under the present disclosure, the cost equation can be adjusted. Adjusting cost estimates can include using z_{adj} (adjusted labor overhead z) to provide more accurate labor overhead. Adjusted price of materials (a_{adj}) or equipment (b_{adj})can be used as well.

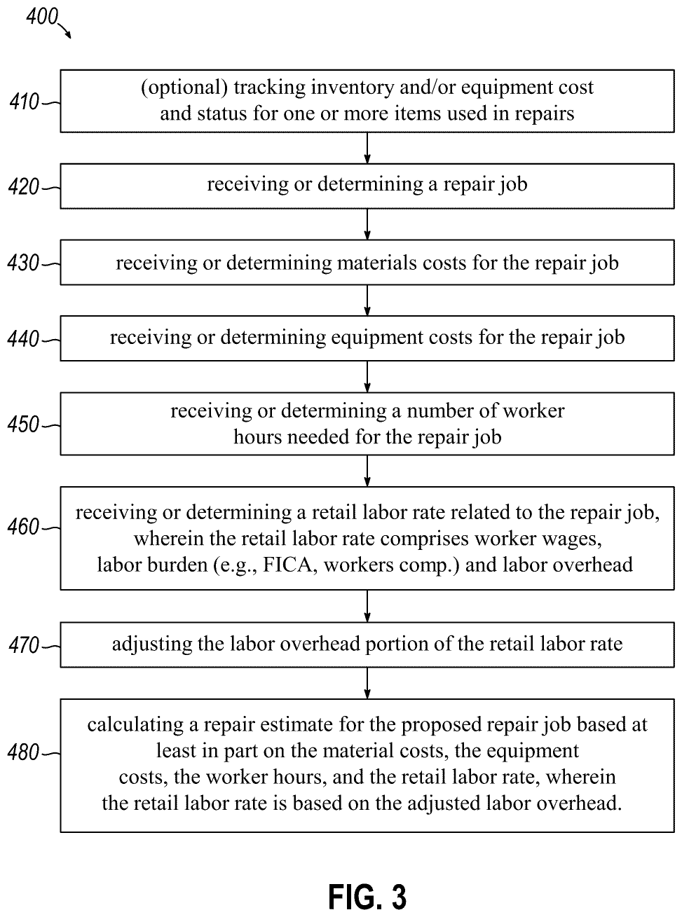

FIG. 3 displays a possible method embodiment under the present disclosure. Method 400 can comprise a method performed by an inventory tracking system (e.g., System 100 of Figure) for providing a quote for repair costs. Step 410, optional, is tracking inventory and/or equipment cost and status for one or more items used in repairs. Step 420 is receiving or determining a repair job. Step 430 is receiving or determining materials costs for the repair job. Step 440 is receiving or determining equipment costs for the repair job. Step 450 is receiving or determining a number of worker hours needed for the repair job. Step 460 is receiving or determining a retail labor rate related to the repair job, wherein the retail labor rate comprises worker wages, labor burden (e.g., FICA, workers' comp.) and labor overhead. Step 470 is adjusting the labor overhead portion of the retail labor rate. Step 480 is calculating a repair estimate for the proposed repair job based at least in part on the material costs, the equipment costs, the worker hours, and the retail labor rate, wherein the retail labor rate is based on the adjusted labor overhead. Method 400 can comprise a variety of alternative or additional steps. Various of the steps described can be omitted while still keeping within the teachings of the present disclosure. Method 400 can comprise receiving various values from a prior art program, such as Xactimate. But Xactimate's value for labor overhead will usually need to be adjusted. Because Xactimate does not adjust labor overhead, the repair costs calculated by Xactimate tend to be low, and not accurate representations of the costs experienced by a repair company.

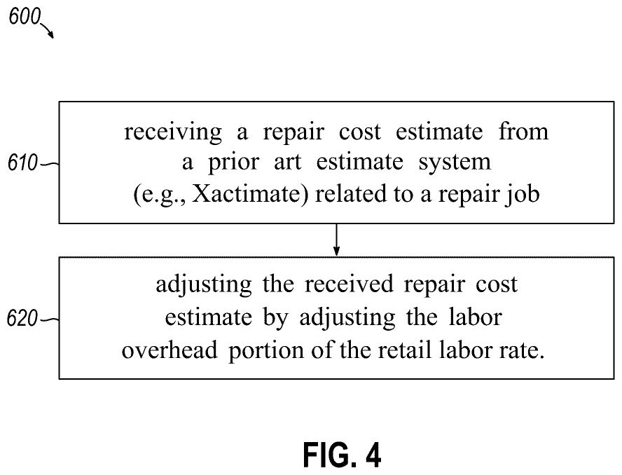

FIG. 4 displays another possible method embodiment 600 under the present disclosure. Step 610 is receiving a repair cost estimate from a prior art estimate system (e.g., Xactimate) related to a repair job. Step 620 is adjusting the received repair cost estimate by adjusting the labor overhead portion of the retail labor rate. Method 600 can comprise a variety of additional or alternative steps.

Although the computing devices described herein (e.g., servers, computers) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on or in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

In other certain embodiments, some or all of the functionality described herein may be provided as part of a mobile application, which in certain embodiments the processing of the estimated cost takes place on the mobile device using data supplied by one or more remote servers where the data is stored. Such data is supplied to the mobile device when requested by the user of the mobile application. In such an embodiment, the certification to obtain the data stored on the one or more remote servers is not available unless accessed within the mobile application on the device.

In other certain embodiments, some or all of the functionality described herein may be provided as part of a computer application, which in certain embodiments the processing of the estimated cost takes place on the computer using data supplied by one or more remote servers where the data is stored. Such data is supplied to the computer when requested by the user of the mobile application. In such an embodiment, the certification to obtain the data stored on the one or more remote servers is not available unless accessed within the mobile application of the device. In alternative embodiments, the calculations may occur remotely, with the computer application serving only to request the information and relay that information back to the user.

In other certain embodiments, some or all of the functionality described herein may be provided as the primary function of a specialized portable device configured to quickly and easily query data supplied by one or more remote servers, then calculate a repair quote using the queried data. In alternative embodiments, the calculations may occur remotely, with the specialized portable device serving only to request the information and relay that information back to the user.

What is claimed is:

1. A method performed by an inventory tracking system for deriving repair costs for a proposed repair job, the method comprising:
tracking inventory cost and status for one or more items used in repairs;
tracking equipment cost and status for one or more items used in repairs;
receiving a repair job;
determining materials costs for the repair job;
determining equipment costs for the repair job;
determining a number of worker hours needed for the repair job;
determining a retail labor rate related to the repair job, wherein the retail labor rate comprises worker wages, labor burden and labor overhead;
adjusting the labor overhead portion of the retail labor rate; and
calculating a repair estimate for the proposed repair job based at least in part on the material costs, the equipment costs, the worker hours, and the retail labor rate, wherein the retail labor rate is based on the adjusted labor overhead.

2. The method of claim 1, wherein the material costs, equipment costs, the worker hours, and the retail labor rate for the repair job are determined from data stored remotely on storage servers.

3. The method of claim 2, wherein the calculation of the repair estimate occurs locally on a device employed by the user to determine the repair costs.

4. The method of claim 1, wherein a remote server calculates the repair estimate using values for the material costs, the equipment costs, the worker hours, and the retail labor rate stored on the remote server.

5. The method of claim 1, wherein the material costs, equipment costs, the worker hours, and the retail labor rate for the repair job are determined by manual input by the user.

6. The method of claim 1, wherein a computer calculates the repair estimate as part of a process of a computer application.

7. The method of claim 6, wherein the material costs, the equipment costs, the worker hours, and the retail labor rate are stored in the memory of servers located on the same local area network as the computer calculating the repair estimate.

8. The method of claim 7, wherein the computer calculating the repair estimate queries the servers for the values of material costs, the equipment costs, the worker hours, and the retail labor rate when a user requests a repair cost estimate.

9. The method of claim 1, wherein a mobile phone calculates the repair estimate by running a mobile application.

10. The method of claim 9, wherein the mobile phone determines the values of the material costs, the equipment costs, the worker hours, and the retail labor rate by querying remote servers containing that information.

11. The method of claim 9, wherein the material costs, the equipment costs, the worker hours, and the retail labor rate are determined by values input by the user.

12. The method of claim 1, wherein a specialized portable device calculates the repair estimate.

13. The method of claim 12, wherein the specialized portable device determines the values of the material costs, the equipment costs, the worker hours, and the retail labor rate by querying remote servers containing that information.

14. A system for tracking inventory and material costs and providing repair estimates comprising:
processing circuitry; and
a memory, the memory containing instructions executable by the processing circuitry whereby the system is operative to:
track inventory cost and status for one or more items used in repairs;
track equipment cost and status for one or more items used in repairs;
receive a repair job;
determine materials costs for the repair job;
determine equipment costs for the repair job;
determine a number of worker hours needed for the repair job;
determine a retail labor rate related to the repair job, wherein the retail labor rate comprises worker wages, labor burden, and labor overhead;
adjust the labor overhead portion of the retail labor rate; and
calculate a repair estimate for the proposed repair job based at least in part on the material costs, the equipment costs, the worker hours, and the retail labor rate, wherein the retail labor rate is based on the adjusted labor overhead.

15. The system of claim 14, wherein the material costs, the equipment costs, the worker hours, and the retail labor rate are determined by querying a remote server which stores and maintains those values.

16. The system of claim 14, wherein the memory contains additional instructions whereby the system is further operative to:
receive a repair cost estimate from a third party estimate system related to a repair job; and
adjust the received repair cost estimate by adjusting the labor overhead portion of the retail labor rate.

17. A method performed by an inventory tracking system for deriving repair costs for a proposed repair job, the method comprising:
receiving a repair cost estimate from a third party estimate system related to a repair job; and
adjusting the received repair cost estimate by adjusting the labor overhead portion of the retail labor rate.

18. The method of claim 17, wherein values for adjusting the labor overhead portion of the retail labor rate are stored on a remote server.

19. The method of claim 18, wherein the labor overhead adjustment occurs on the remote server.

20. The method of claim 18, wherein the labor overhead adjustment occurs on a device employed by the user, with the values used in calculating the labor overhead adjustment supplied by a remote server.
